(19) United States
(12) Patent Application Publication
(10) Pub. No.: US 2014/0164940 A1
(43) Pub. Date: Jun. 12, 2014

(54) APPLICATION WINDOWS AND DISPLAY DEVICES

(71) Applicant: DISPLAYLINK (UK) LIMITED, Cambridge (GB)

(72) Inventor: Andrew John Fisher, Cambridge (GB)

(73) Assignee: DISPLAYLINK (UK) LIMITED, Cambridge (GB)

(21) Appl. No.: 13/708,456

(22) Filed: Dec. 7, 2012

(51) Int. Cl. G06F 3/048

(52) U.S. Cl. CPC G06F 3/048
USPC 715/741

(57) ABSTRACT

A method of displaying application windows (18) on display devices (12) includes maintaining a designation of an application window as either public or private, maintaining a designation of a display device as either public or private, receiving an input directing the display of a private application window on a public display device, and preventing or adjusting the display of the private application window on the public display device, e.g. by obscuring the contents, blacking out a window, making a window invisible, or restricting a window from being dragged onto another display device.

### BACKGROUND OF THE INVENTION

1. Field of the Invention

This invention relates to a method of, and system for, displaying application windows on display devices.

2. Description of the Related Art

In desktop computing, it is now common to use more than one display device. Traditionally, a user would have a computer with a single display device attached, but now it is possible to have more than one display device attached to the computer, which increases the usable area for the worker. For example, International Patent Application Publication WO 2007/020408 discloses a display system which comprises a plurality of display devices, each is displaying respectively an image, a data processing device connected to each display device and controlling the image displayed by each display device, and a user interface device connected to the data processing device. Connecting multiple display devices to a computer is a proven method for improving productivity.

In relation to the control of the output of the multiple display devices, utilities such as UltraMon (see realtimesoft.com/ultramon/) are available. UltraMon is a utility for multi-monitor systems, which is designed to unlock the full potential of multiple monitors. UltraMon can move windows and maximize windows across the desktop, manage applications with the Smart Taskbar, control application positioning, provide multi-monitor support for desktop wallpapers and screen savers, and mirror the user's main monitor to secondary monitors for a presentation. This latter facility, which allows a user to replicate their current display device (such as a laptop screen) on a larger presentation display device, allows multiple individuals to see the current display of the user's primary display device.

Currently, if a user is running Microsoft Windows in a multi monitor environment, all Windows applications can be displayed on all the monitors that are connected, either in an extended desktop or cloned desktop configuration. There are no restrictions as to where Windows applications can be displayed. One of the most embarrassing things that can happen when giving a presentation is if a Windows pop-up containing the user's personal emails or an instant messenger pop-up appears on the same monitor or projector on which their presentation is running. This can occur if the user is running Windows in a dual monitor or multi monitor environment as, currently, all Windows applications can be displayed on all the monitors which are connected, either in an extended desktop or cloned desktop configuration.

### BRIEF SUMMARY OF THE INVENTION

According to a first aspect of the present invention, there is provided a method of displaying application windows on display devices comprising maintaining a designation of an application window as either public or private, is maintaining a designation of a display device as either public or private, receiving an input directing the display of a private application window on a public display device, and preventing or adjusting the display of the private application window on the public display device.

According to a second aspect of the present invention, there is provided a system for displaying application windows on display devices comprising a plurality of display devices and a processing device connected to the display devices, the processing device arranged to maintain a designation of an application window as either public or private, maintain a designation of a display device as either public or private, receive an input directing the display of a private application window on a public display device, and prevent or adjust the display of the private application window on the public display device.

According to a third aspect of the present invention, there is provided a computer program product on a computer readable medium for displaying application windows on display devices, the product comprising instructions for maintaining a designation of an application window as either public or private, maintaining a designation of a display device as either public or private, receiving an input directing the display of a private application window on a public display device, and preventing or adjusting the display of the private application window on the public display device.

Owing to these aspects of the invention, it is possible to provide public/private windows and monitors. The idea behind the public/private windows and monitors is to configure application windows to be either public or private, and also designate display devices to be either public or private.

Public windows can be displayed on both public and private monitors. Private windows can only be displayed on private monitors. This configuration would restrict application windows that contain private information from appearing on monitors that may be displaying information in a public environment, or to a different audience. The computing device which is controlling the display of the plurality of display devices will ensure that an application window that is designated as private will not be shown on a display device that is designated as public, either by preventing totally the display of the window or by adjusting the display of the window (for example by obscuring the contents). The prevention or adjustment will happen whether a user or an automated process attempts to display a private application window on a public display device.

Preferably, the method further comprises displaying an application window and receiving a predefined user input in respect of the displayed application window, the predefined user input designating the application window as private. The user can be provided with a simple way of designating an application window as private. This could be via navigating a menu that can be accessed for the window and/or the underlying application or could be via an icon that is displayed, for example, alongside the conventional minimise, maximise and close icons that are conventionally displayed in the top right hand corner of an open application window.

Advantageously, the method further comprises detecting the connection of a new display device and designating the new display device as public. To create a useful extension to the designation of display devices as public or private, the computing system can be configured so that the default setting for any new display device that is connected to the computing system is that the display device is considered to be public. This is the safest option in relation to protecting private content and will also in practical terms will cover the real situation when a user, for example, connects their laptop to a presentation display device in preparation for making a public presentation. The new display device (the presentation system) will be designated as a public display device automatically by the computing system controlling the display content.

The opposite configuration is also possible, whereby any new display device is designated as private. Although this would allow the display of private windows on the new display device, which may not be ideal if the new device is in a public area, this will avoid confusing users who are not familiar with the public/private designations of windows and display devices. An alternative arrangement is for a pop-up to be generated when the user connects the new display device, which will request a user input regarding the designation of the new display device, which will be designated as public or private, in response to the received user input.

Ideally, the method further comprises displaying the public/private designations of the application windows and display devices and receiving a user input changing the designation of one or more application windows and/or display devices. The designation of windows and display devices as public and private can be controlled from a dedicated application. This dedicated application can be provided with its own graphical user interface which the user can access to see the current designations for current application windows and display devices. The user can make changes within the graphical user interface to any designations that exist and these will change the behaviour of the processing device in relation to the specific application window or display device.

Preferably, the method further comprises storing a public/private designation for an application and designating an application window for the application as public or private according to the stored public/private designation for the application. Although the method and system work at the level of an application window, the designation of public or private can be attached to an application per se, with that designation acting as the default for any application window that is opened for that application. It is also possible that when a user makes a designation for an application window, that designation is attached to the application per se and is used for any future windows opened for that application. This relationship between a designation for an application window and for the application per se can be set by the user as a global population of the designation or could be specific to individual applications. For example, the processing device could be arranged to always attach a designation to an application per se following a selection made by a user in relation to a specific application window. Alternatively, the user could be asked, at the time that they make the designation for an application window whether they wish that designation to apply to the specific application per se.

According to a fourth aspect of the present invention, there is provided a method of controlling audio output on display devices comprising maintaining a designation of an application window as either public or private, maintaining a is designation of a display device as either public or private, receiving an instruction directing an audio output for a private application window on a public display device, and preventing or adjusting the audio output for the private application window on the public display device.

According to a fifth aspect of the present invention, there is provided a system for controlling audio output on display devices comprising a plurality of display devices and a processing device connected to the display devices, the processing device arranged to maintain a designation of an application window as either public or private, maintain a designation of a display device as either public or private, receive an instruction directing an audio output for a private application window on a public display device, and prevent or adjust the audio output for the private application window on the public display device.

Owing to these aspects of the invention, it is possible to extend the public/private window concept to cover audio outputs. For example, many display interconnects have the ability to also carry audio. With a USB connected display it is also common to have speakers in the monitor with the audio data travelling along with the video over the USB connection. This means that, for example when a user plugs their laptop into a projector, audio is also routed to the speakers associated in the display device. This is inconvenient if an email arrival sound or an incoming call ring is amplified for all to hear during a presentation. The private and public windows concept is extended to cover audio outputs as well as the actual display of windows. For example, as the email program is a private application, then the audio it produces should not come out of speakers attached to or embedded in a public display.

### BRIEF DESCRIPTION OF THE SEVERAL VIEWS OF THE DRAWINGS

Embodiments of the present invention will now be described, by way of example only, with reference to the accompanying drawings, in which:

FIG. 1 is a schematic diagram of a display system,

FIG. 2 is a schematic diagram of a second embodiment of a display system,

FIG. 3 is a table showing the effect of public/private designations,

FIG. 4 is a schematic diagram of an application window,

FIG. 5 is a schematic diagram of a graphical user interface of a utility, and

FIG. 6 is a flowchart of a display method.

### DETAILED DESCRIPTION OF THE INVENTION

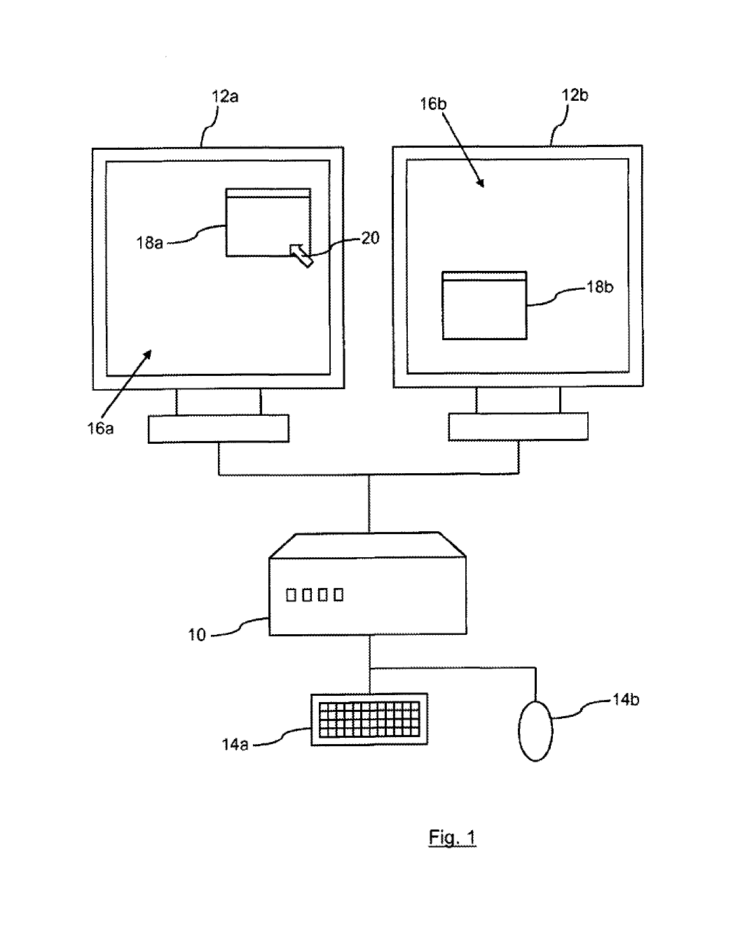

A display system is shown in FIG. 1. The system comprises a processing device 10, display devices 12 and user interface devices 14. The user interface devices are a keyboard 14a and a mouse 14b. The system shown in FIG. 1 is a standard desktop computer, with an additional display device 12b, which is composed of discrete components that are locally located but could equally be a device such as a laptop computer or suitably enabled handheld device such as a mobile phone or pda (personal digital assistant) all using an additional display 12b. Similarly, the system may comprise part of a networked or mainframe computing system, in which case the processing device 10 may be located remotely from the user input devices 14 and the display devices 12, or indeed may have its function distributed amongst separate devices.

The display devices 12 show images 16, and the display of the images 16 is controlled by the processing device 10. One or more applications are running on the processing device 10 and these are represented to the user by corresponding application windows 18, with which the user can interact in a conventional manner. A cursor 20 is shown, and the user can control the movement of the cursor 20 about the images 16 shown on the display device 12 using the computer mouse 14b, again in a totally conventional manner. The user can perform actions with respect to any running application via the user interface device 14 and these actions result in corresponding changes in the images 16, displayed by the display device 12.

The operating system run by the processing device uses virtual desktops to manage the multiple display devices 12. Each physical display device 12 is represented by a frame buffer that contains everything currently shown on that display device 12. The operating system is configured to arrange these frame buffers into a single virtual desktop. When these frame buffers are arranged in the virtual desktop in the same relative positions in which the physical display devices 12 are relatively placed, then the operating system can draw objects on all the display devices 12 in a natural way. The virtual desktop is a combination of the respective images 16a and 16b being shown by the display devices 12. If the user moves the mouse 14a such that the cursor 20 moves right off the edge of one display device 12a, then the cursor 20 appears on the left of the display device 12b to the right. Similarly a window 18 spread across several display devices 12 appears properly lined up between the display devices 12.

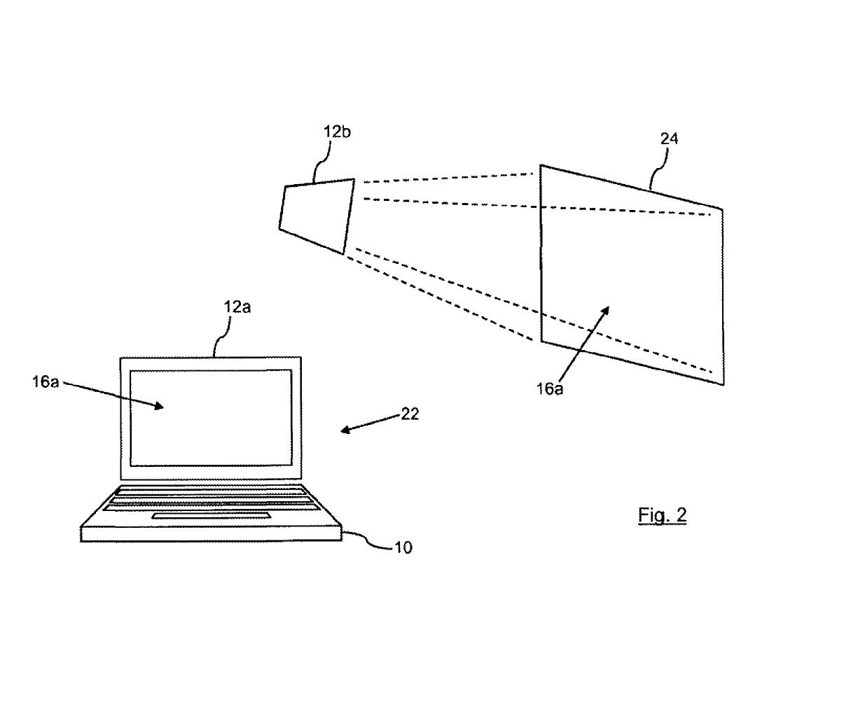

An alternative arrangement is shown in FIG. 2. The display system still comprises two display devices 12a and 12b, but the primary display device 12a forms part of a laptop computer 22, and the secondary display device 12b is a projection system that is projecting onto a screen 24. The screen 24 could be a simple whiteboard or the wall of a room. The laptop 22 communicates with the projector 12b, either directly via a wireless connection such as WiFi, or via an internal general purpose data network such as an Ethernet system. Conventional display technologies such as VGA may also be used. The user has access to their laptop in order to make a presentation using the projector 12b and the screen 24.

Unlike the example of FIG. 1, where the images 16 shown by the individual display devices 12a and 12b is different, in the example of FIG. 2, the image 16a that is displayed by the primary display device 12a and the secondary display device 12b is identical. The projector 12b is controlled to display exactly the image 16a that is being displayed on the display device 12a of the laptop 22. The user can launch applications on their laptop 22 and the corresponding application windows that appear on the display device 12a will also appear on the image 16a projected by the projector 12b. In this way a user can deliver a suitable presentation to a wider audience.

Any user interactions with applications that result in changes to the display of a corresponding application window 18, or indeed the cursor 20, will cause the display 12a on the laptop 22 to change, but will also result in the same change appearing on the image 16a projected by the projector 12b.

Although this is desired in respect of the user's presentation, any changes to the image 16a shown by display device 12a that happen automatically, may not be so desired. For example, it is common in applications such as email and instant messaging for the application to continue running in the background, even when no application window 18 is visible. This creates the possibility of an application window 18 appearing on the display device 12a unexpectedly and this change being reflected in the image 16a displayed by the projector 12b.

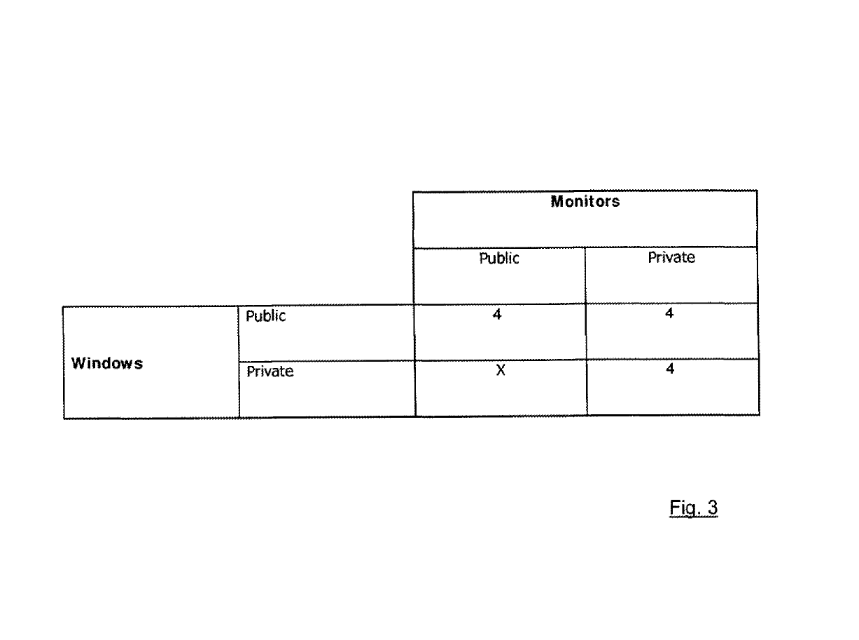

In order to solve the above problem of unwanted material being displayed on a secondary display device 12b, the processing device 10 is configured to provide public/private windows and display devices. The processing device 10 configures application windows 18 to be either public or private, and also designates display devices 12 in the same way. Public windows 18 can be displayed on both public and private display devices 12. However, private windows 18 can only be displayed on private display devices 12. This is summarised in the table of FIG. 3. This allows a user to designate an application window 18 for an email client (for example) as private and the projector 12b as a public display device 12b.

This configuration would restrict application windows 18 that contain private information from appearing on display devices 12 that may be displaying information in a public environment, or to a different audience. The processing device 10, which is controlling the display of the different display devices 12, will ensure that an application window 18 that is designated as private will not be shown on a display device 12 that is designated as public or will be adjusted so that the contents are obscured. The prevention/adjustment will happen whether a user or an automated process attempts to display a private application window 18 on a public display device 12. So in the above example, the contents of the application window 18 for the email client can never be displayed on the secondary display device 12b.

The method for implementing this restriction on displaying windows 18 can be achieved in different ways for example, by blacking-out an application window 18 on the display device 12 where it is restricted from being displayed or by making an application window 18 invisible on the display device 12 where it is restricted from being displayed. In the configuration of FIG. 1, where the image 16b displayed by the secondary display device 12b is an extension of the image 16a being displayed by the primary display device 12a, the processing device 10 can be configured to stopping an application window 18 at the display boundary, restricting the window 18 from being dragged onto another display device 12, or from being displayed on another display device 12.

The processing device 10 can control a display device 12 to display an application window 18 and receive a predefined user input in respect of the displayed application window 18, so that the user can designate the application window 18 as private. In this way, the user can be provided with a simple way of designating an application window 18 as private. This could be via navigating a menu that can be accessed for the window 18 and/or the underlying application or could be via an icon that is displayed, for example, alongside the conventional minimise, maximise and close icons that are conventionally displayed in the top right hand corner of an open application window.

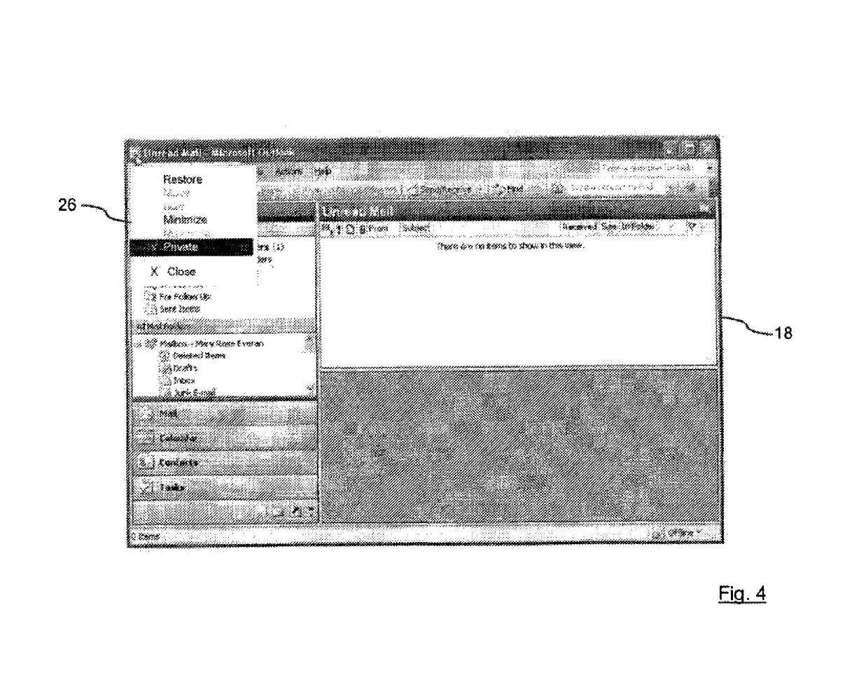

In Microsoft Windows, the standard window menu 26 is accessible via the application icon in the title bar on the top left hand corner of a window 18, as shown in FIG. 4. This menu 26 can be extended to provide other window functionality. It can therefore be used to add more menu options to configure the particular application window 18 to be either public or private. For example, the menu option “Private” can be added, as shown in this Figure. If the private attribute is not applied, then all new application windows 18 would default to being public. Once the user has brought up the menu 26 they can select the “Private” option to designate the specific window 18 as private, and this window will not be shown on any display devices 12 that are designated as public.

The configuration of display devices 12 will also be user accessible. Each display device 12 will require a configuration procedure to set it to being public or private. The user can access a suitable utility to access and configure the settings of the display devices 12 that are currently connected to the processing device 10. The processing device can also be arranged to detect the connection of a new display device 12 and designate the new display device 12 as public. The processing device 10 is therefore configured so that the default setting for any new display device 12 that is connected to the computing system is that the display device 12 is considered to be public.

This is the safest option for protecting the user's private content.

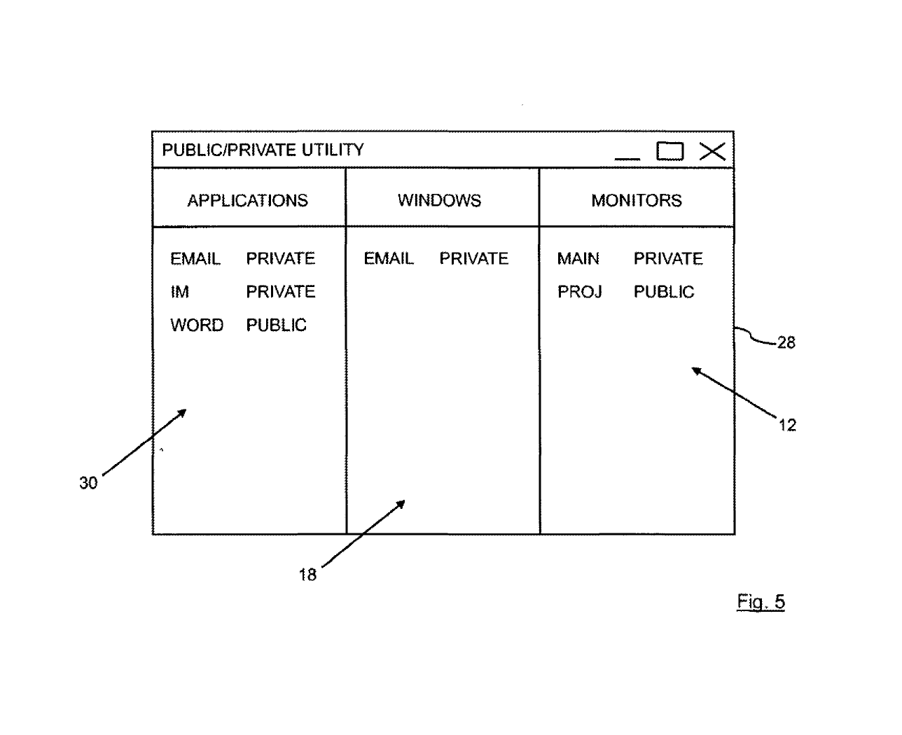

The user can access the utility which will display the public/private designations of the application windows 18 and display devices 12 and will allow the user to change the designation of one or more application windows and/or display devices. The designation of windows and display devices as public and private can be controlled from this dedicated utility, which has its own graphical user interface 28, as shown in FIG. 5. The user can access the interface 28 to see the designations for current application windows 18 and display devices 20. The user can make changes within the graphical user interface 28 to any designations and these will change the behaviour of the processing device 10 in relation to the specific application window 18 or display device 12 for which a change has been made. Any designations that are recorded within the utility will persist in all future uses of display devices by the user. For example, the designations will persist through any powering on or off of the relevant computing and display devices.

Additionally, the utility can store a public/private designation for an application 30 and designate an application window 18 for the application 30 as public or private according to the stored public/private designation for the application 30. Although the utility works at the level of an application window 18, the designation of public or private can be attached to an application 30 per se. The designation in relation to an application 30 can act as the default designation for any application window 18 that is opened for that application 30. In FIG. 5, it can be seen that the email application and the instant messaging application (IM) both have a global designation of “private”. When a window 18 is opened for these applications 30, then they will take this designation.

It is also possible that when a user makes a designation for an application window 18, that this designation is attached to the application 30 per se and is used for any future windows 18 opened for that application 30.

This means that a user does not have to continually designate an application window 18 as private every time they open a new window 18 for that application 30. The utility can be arranged to always attach a designation to an application 30 per se following a selection made by a user in relation to an application window 18. Alternatively, the user could be asked, at the time that they make the designation for an application window 18, whether they wish that designation to always apply to the specific application 30.

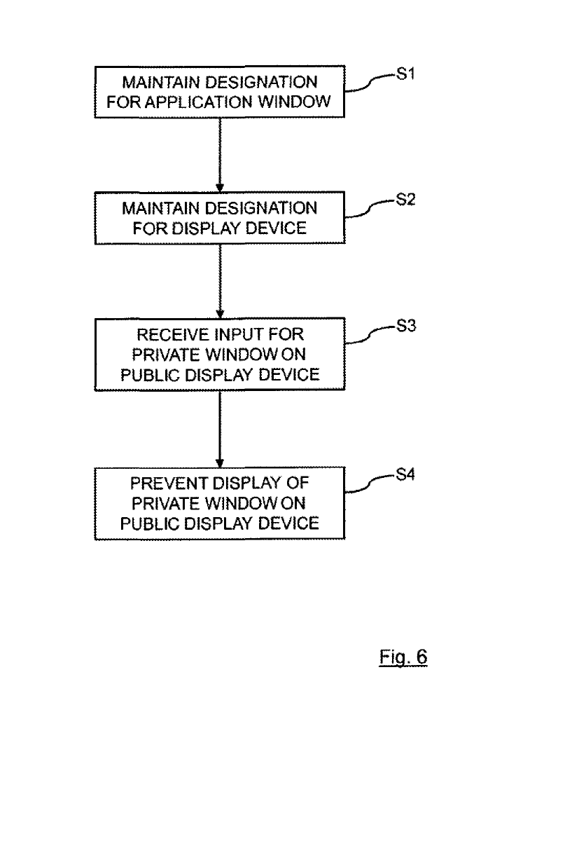

The method of displaying application windows 18 on display devices 12 is summarised in FIG. 6. The method comprises the steps of, firstly step S1 of maintaining a designation of an application window 18 as either public or private, secondly step S2 of maintaining a designation of a display device as either public or private, thirdly, step S3 of receiving an input directing the display of a private application window 18 on a public display device 12, and finally step S4 of preventing or adjusting the display of the private application window 18 on the public display device 12. All other combinations of public/private windows 18 and display devices 12 are permitted.

The processing device 10 must ensure that no private application windows 18 are displayed on any display device 12 that is designated as public. The processing device 10 will act to prevent the display, as detailed above, if a user or automated process tries to place a private application window 18 on a public display device 12. The preventative action that is to be taken can be one of several different actions, such as blocking the display of the private window 18 on the public display 12 or may take the form of allowing the display of the window 18, but obscuring the content. In this way, the user's private content will be protected.

This public/private designation of windows and applications can also be used to restrict window sounds to being either private or public. The concept is therefore extended to cover audio outputs. Many of the newer display interconnects have the ability to also carry audio. Technologies such as HDMI and DisplayPort are two examples of display connections technologies that can additionally carry audio. With a USB connected display it is also common to have speakers in the monitor with the audio data travelling along with the video over the USB connection.

This convergence means that it is now becoming the case that when a user plugs their laptop into a big display or projector, audio is also routed to the speakers associated (or embedded) in the display device. This is a significant advantage if a user wants to play a movie on their television or projector, from their laptop, for example. However, it is also inconvenient if the email arrival sound or maybe an incoming Skype call ring is amplified for all to hear during a presentation. The private and public windows concept is extended to cover audio outputs as well as the actual display of windows. For example, as the email program is a private application, then the audio it produces should not come out of speakers attached to or embedded in a public display.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of displaying application windows on display devices comprising:
maintaining a designation of an application window as either public or private,
maintaining a designation of a display device as either public or private,
receiving an input directing the display of a private application window on a public display device, and
preventing or adjusting the display of the private application window on the public display device.

2. A method according to claim 1, and further comprising displaying an application window and receiving a predefined user input in respect of the displayed application window, the predefined user input designating the application window as private.

3. A method according to claim 1, and further comprising detecting the connection of a new display device and designating the new display device as public.

4. A method according to claim 1, and further comprising displaying the public/private designations of the application windows and display devices and receiving a user input changing the designation of one or more application windows and/or display devices.

5. A method according to claim 1, and further comprising storing a public/private designation for an application and designating an application window for the application as public or private according to the stored public/private designation for the application.

6. A system for displaying application windows on display devices comprising a plurality of display devices and a processing device connected to the display devices, the processing device arranged to:
maintain a designation of an application window as either public or private,
maintain a designation of a display device as either public or private,
receive an input directing the display of a private application window on a public display device, and
prevent or adjust the display of the private application window on the public display device.

7. A system according to claim 6, the processing device further arranged to display an application window on a display device and to receive a predefined user input in respect of the displayed application window, the predefined user input designating the application window as private.

8. A system according to claim 6, the processing device further arranged to detect the connection of a new display device and designate the new display device as public.

9. A system according to claim 6, the processing device further arranged to display the public/private designations of the application windows and display devices on a display device and to receive a user input changing the designation of one or more application windows and/or display devices.

10. A system according to claim 6, the processing device further arranged to store a public/private designation for an application and designate an application window for the application as public or private according to the stored public/private designation for the application.

11. A computer program product on a tangible computer readable medium for displaying application windows on display devices, the product comprising instructions for:
maintaining a designation of an application window as either public or private,
maintaining a designation of a display device as either public or private,
receiving an input directing the display of a private application window on a public display device, and
preventing or adjusting the display of the private application window on the public display device.

12. A computer program product according to claim 11, and further comprising instructions for displaying an application window and receiving a predefined user input in respect of the displayed application window, the predefined user input designating the application window as private.

13. A computer program product according to claim 11, and further comprising instructions for detecting the connection of a new display device and designating the new display device as public.

14. A computer program product according to claim 11, and further comprising instructions for displaying the public/private designations of the application windows and display devices and receiving a user input changing the designation of one or more application windows and/or display devices.

15. A computer program product according to claim 11, and further comprising instructions for storing a public/private designation for an application and designating an application window for the application as public or private according to the stored public/private designation for the application.

16. A method of controlling audio output on display devices comprising:
maintaining a designation of an application window as either public or private,
maintaining a designation of a display device as either public or private,
receiving an instruction directing an audio output for a private application window on a public display device, and
preventing or adjusting the audio output for the private application window on the public display device.

17. A system for controlling audio output on display devices comprising a plurality of display devices and a processing device connected to the display devices, the processing device arranged to:
maintain a designation of an application window as either public or private,
maintain a designation of a display device as either public or private,
receive an instruction directing an audio output for a private application window on a public display device, and
prevent or adjust the audio output for the private application window on the public display device.

18. A computer program product on a tangible computer readable medium for controlling audio output on display devices, the product comprising instructions for:
maintaining a designation of an application window as either public or private,
maintaining a designation of a display device as either public or private,
receiving an instruction directing an audio output for a private application window on a public display device, and
preventing or adjusting the audio output for the private application window on the public display device.
